(19) United States
(12) Patent Application Publication
(10) Pub. No.: US 2026/0081675 A1
(43) Pub. Date: Mar. 19, 2026

(54) METHODS AND SYSTEMS FOR DEVELOPING NETWORK CONNECTIONS ACROSS RELAYS WITH MULTIMODAL SIGNALS

(71) Applicant: T-Mobile USA, Inc., Bellevue, WA (US)

(72) Inventor: Chad C. Au, Kirkland, WA (US)

(21) Appl. No.: 18/888,117

(22) Filed: Sep. 17, 2024

(51) Int. Cl. H04B 7/185; H04W 24/02

(52) U.S. Cl. CPC H04B 7/18513; H04W 24/02

(57) ABSTRACT

The invention relates to a method and system for establishing a network connection across a relay with multimodal signals. The relay includes an antenna, an outdoor unit, and an indoor unit. The method includes detecting a radio signal at the antenna, converting it to an electrical signal, and transmitting it to the outdoor unit. Signal parameters are measured at the antenna and outdoor unit to predict the signal's outdoor status. The electrical signal is converted to an optical signal, sent to the indoor unit, and converted to an electrical signal. Signal parameters are measured at the indoor unit to predict the indoor status. A recommended action for developing the network connection is identified based on the combined statuses and provided to the user.

### BACKGROUND

Telecommunications involves the transmission of information over distances using electronic systems, such as telephones, radios, televisions, and the internet. It enables voice, data, and video communication, connecting people and businesses worldwide. One of the latest advancements in telecommunications is 5G, the fifth generation of mobile network technology. As 5G networks offer significantly higher speeds, lower latency, and greater connectivity compared to previous generations, they enable a wider range of services and applications, such as the Internet of Things (IoT), smart cities, and advanced mobile broadband.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates components of a system for developing a network connection across a relay with multimodal signals.

FIG. 4 is a flowchart that illustrates a method for developing a network connection across a relay with multimodal signals.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to methods and systems for developing network connections across relays with multimodal signals. In some implementations, relays with multimodal signals include an Indoor Unit (IDU) and an Outdoor Unit (ODU) which are connected to each other via an optical connection, and which are also connected to an antenna to allow connectivity to a network. (e.g., a satellite wireless network). For example, the IDU, ODU, and antenna can be comprised by a Barrier Mounted Satellite Terminal System (BMSTS). The IDU and ODU can be mounted to a transparent barrier, such as a window in a home, through which they can maintain an optical connection. The BMSTS can be used to mitigate the indoor propagation losses of typical in-home wireless gateways, as well as allow connectivity to satellite wireless networks.

In some implementations, the relays include unique customer-premises (or customer-provided) equipment (CPE). For example, relays can include routers, telephones, set-top boxes, or other devices located at the customer's premises and connected to the service provider's network.

Developing network connections across relays with multimodal signals can include user applications to establish, improve, or enhance a network connection. For example, a smart phone application with connectivity (e.g. local via Bluetooth, remote via internet) to a relay with multimodal signals can enhance a user's experience by providing greater details of the relay's operational status. The operational status can include an alignment of the ODU and the IDU. In some implementations, the operational status can be used to guide a user for proper installation of the relay and to verify functional alignment between the IDU and the ODU, or of the antenna, functionality of a remote antenna unit (e.g., including a beam forming antenna, a beam former, and a wireless modem), as well as a presence and a quality of satellite coverage. In some implementations, the application can also provide details on connections to peripheral devices (e.g., narrow band-internet of things (NB-IOT) devices, smart utility meters, smart appliances, environmental sensors, home security systems, smart lighting systems, and wearable health monitors), or on connections to other relays. For example, the relay can serve as a host to other functions, devices, and relays.

Current methods for monitoring and developing network connections provide limited information regarding the status of the connection and the devices involved. Other than perhaps a rudimentary status shown by status LEDs, the user will be in the dark about the functionality of their router and the quality of service being received. Little information is available should the system needs troubleshooting. The disclosed technology can provide a solution to the problem of providing useful information about the installation and functionality of a network connection across a relay with multimodal signals, as well as the availability and quality of high-speed internet (HSI) service being delivered. For example, a user application, whether locally or remotely, can allow monitoring and management of additional NB-IOT devices connected downstream via the BMSTS.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

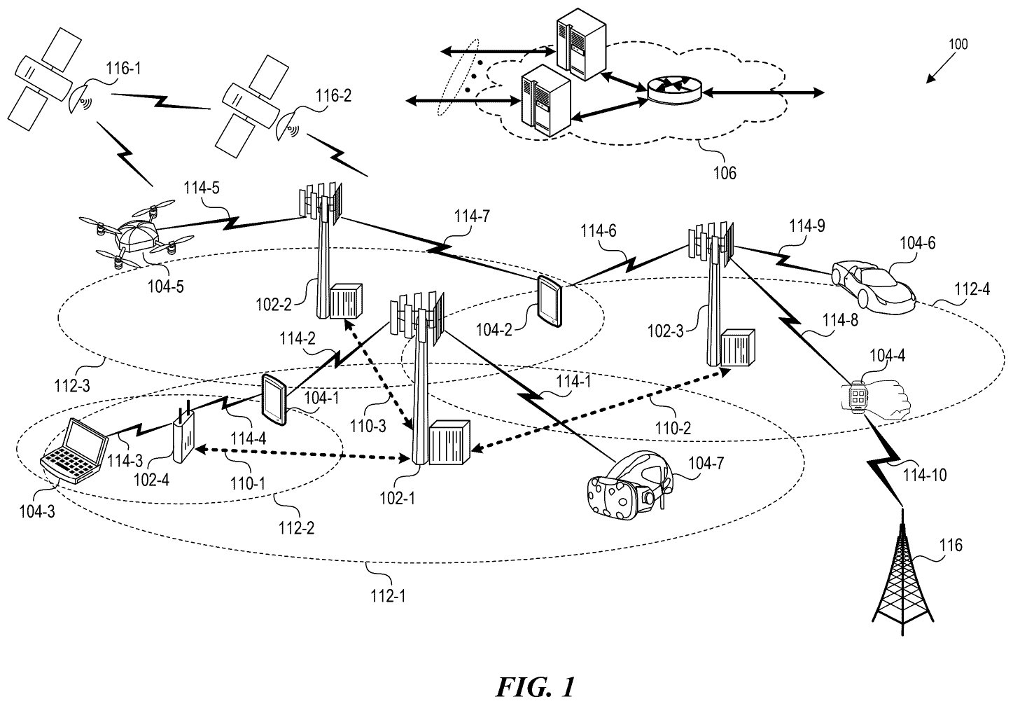

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

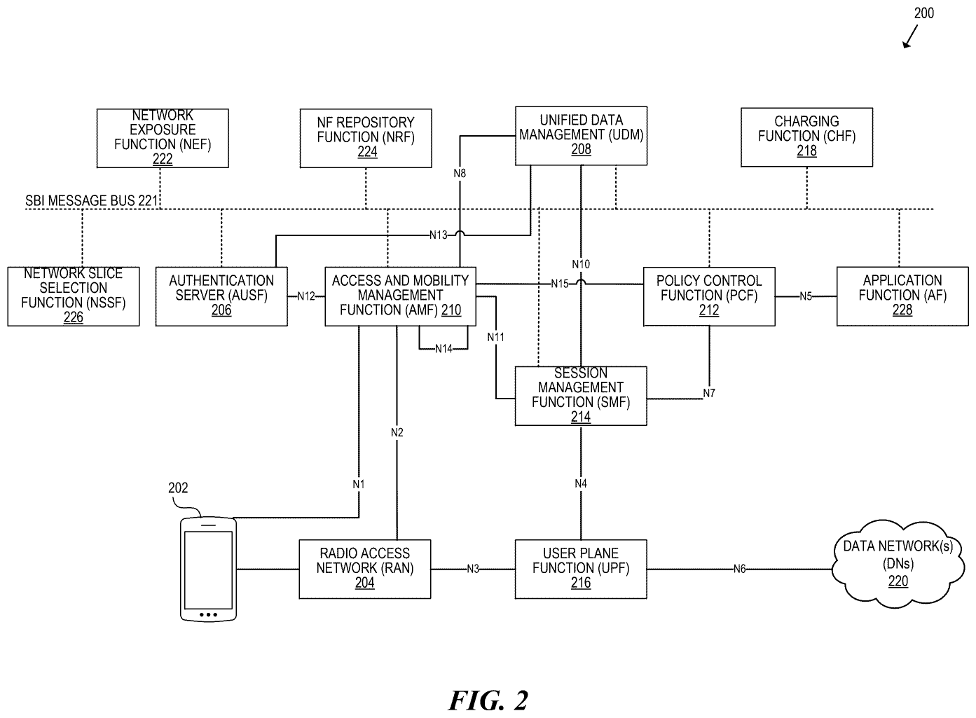

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Developing Network Connections Across Relays With Multimodal Signals

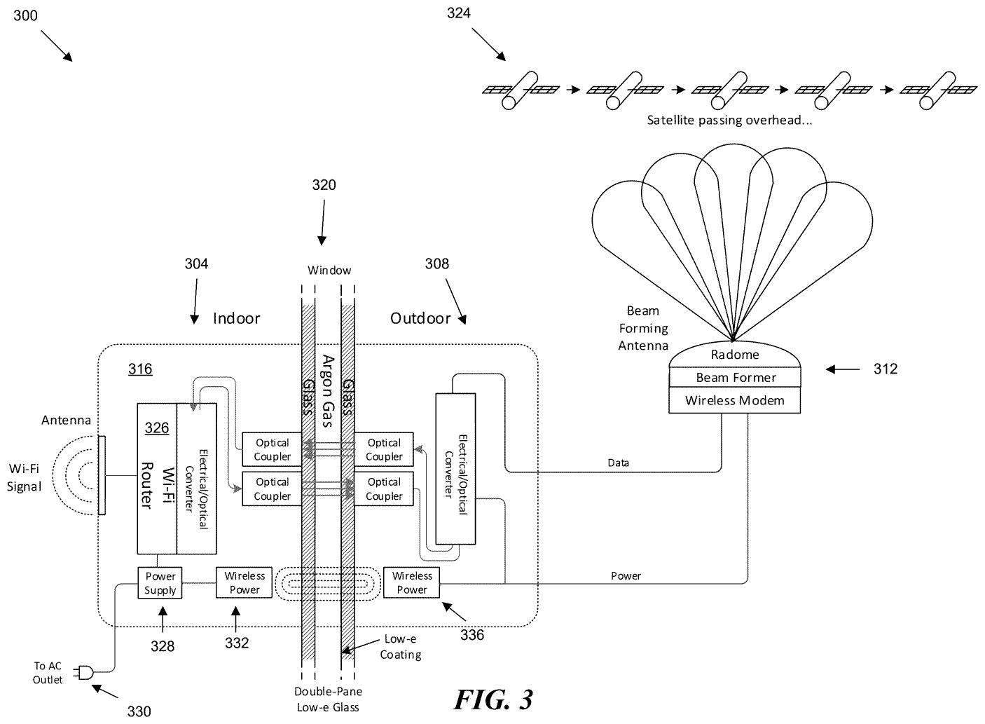

FIG. 3 is a block diagram that illustrates components of a system 300 for developing a network connection across a relay with multimodal signals. In the illustrated example, the relay comprises a barrier-mounted satellite terminal system (BMSTS). The system 300 includes an indoor unit 304 and an outdoor unit 308. The indoor unit 304 can be configured to communicate optical signals with the outdoor unit 308. The indoor unit 304 and the outdoor unit 308 can be configured to convert the optical signals into electrical signals, and vice versa. The optical signals can be communicated via fiber optic cables and free space optical couplers (e.g., collimators). As illustrated, the outdoor unit 308 and the indoor unit 304 can be separated by a transparent barrier 320 (e.g., a window). The outdoor unit 308 and the indoor unit 304 can communicate the optical signals through the transparent barrier 320.

The system 300 can include an antenna 312. The antenna 312 can include a radome, a beam former, and a wireless modem. The antenna 312 can be configured to receive outdoor radio signals (e.g., from a cell site, or from satellites 324) and convert them into the outdoor electrical signals. The outdoor unit 308 can be configured to communicate signals with the antenna 312 through an outdoor electrical connection.

The system 300 includes a management unit 316. As illustrated, the management unit 316 can be comprised by the indoor unit 304. Alternatively the management unit can be comprised by software on a user equipment, or by the outdoor unit, or it can be distributed across some or all of the components of the system 300. In some implementations, the management unit 316 is configured to monitor outdoor radio signals, outdoor electrical signals, and indoor electrical signals. The management unit 316 can be configured to measure changes in signal parameters associated with the signals. In some implementations, the management unit 316 can predict statuses for the antenna 312, the outdoor unit 308, and the indoor unit 304 based on the changes in signal parameters. The management unit 316 can also provide recommended actions to a user based on the predicted statuses.

The system 300 can include a Wi-Fi router 326 that is configured to receive the indoor electrical signals from the indoor unit 304 and convert them into indoor radio signals. The system 300 can include a user equipment that is configured to receive the indoor radio signals from the Wi-Fi router 326 and convert them into data. The data can comprise recommended actions to develop the network connection, which can include multimedia feedback. In some implementations, the management unit 316 is configured to monitor the indoor radio signals, measure changes in signal parameters associated with the indoor radio signals, and predict statuses for the Wi-Fi router 326 and the user equipment based on those changes.

The system 300 can include a power system. The power system can include an indoor power supply 328, an indoor wireless power unit 332, and an outdoor wireless power unit 336. The indoor power supply 328 can be configured to collect power from a power source 330 (e.g., an AC power outlet) and conduct collected power to the indoor unit 304, as well as to the indoor wireless power unit 332. The indoor wireless power unit 332 can be configured to radiate power (e.g., as a Radio Frequency (RF) signal), and the outdoor wireless power unit 336 can be configured to harvest power from RF signals, and to conduct harvested power to the outdoor unit 308 and to the antenna 312. The indoor wireless power unit 332 and the outdoor wireless power unit 336 can separated by the barrier 320.

In implementations that include the power system, the management unit 316 can be configured to monitor the collected power, the radiated power, and the harvested power. The management unit 316 can also predict statuses for the indoor power supply 328, the indoor wireless power unit 332, and the outdoor wireless power unit 336 based on power fluctuations across the system 300. The management unit 316 can provide recommended actions to a user to develop the network connection by improving power in the system 300 based on the predicted statuses.

In some implementations, the recommended actions include changing a position of the indoor wireless power unit 332, or the outdoor wireless power unit 336, or both. Changing the position of the indoor wireless power unit 332, and/or the outdoor wireless power unit 336, can be to correct an alignment of one or both units to improve power radiation and harvesting. Recommended actions can include checking to ensure the indoor power supply 328 is properly connected to the power source 330, as well as examining power connections to ensure they are secure and undamaged. Power connections can include connections between the indoor power supply 328 and the indoor unit 304, between the outdoor wireless power unit 336 and the outdoor unit 308, and between the outdoor wireless power unit 336 and the antenna 312.

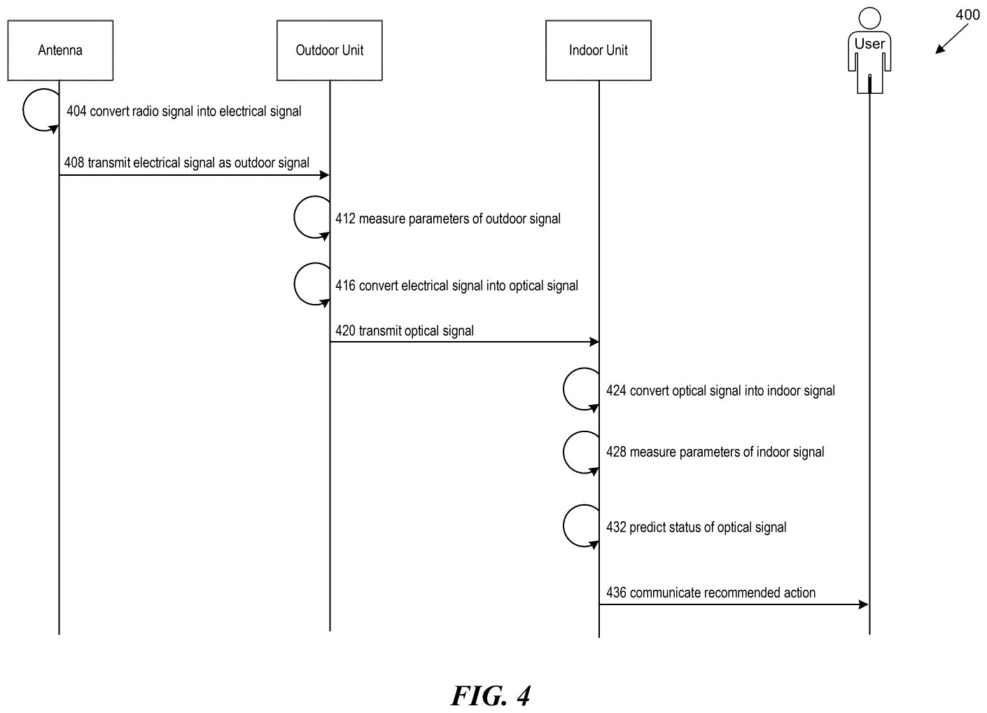

FIG. 4 is a flowchart that illustrates a method 400 for developing a network connection across a relay with multimodal signals. In some implementations, the relay comprises a BMSTS. In some implementations, the relay comprises connections between components. The connections can use multimodal signals to transfer data and/or power between the components. The multimodal signals can comprise electrical and optical signals. Implementations can be contemplated in which the relay also includes radio signals, optical signals transmitted via free-space and fiber-optic, microwave signals, and/or acoustic signals. In some implementations, the method 400 includes an operation 404 in which an antenna converts a radio signal to an electrical signal. The antenna can transform an outdoor radio signal into an outdoor electrical signal. The radio signal can be from a satellite or from a cell tower and can comprise the network connection. The method 400 can include an operation in which the antenna detects an outdoor radio signal. The antenna can also perform the reverse operation, by transforming an electrical signal into a radio signal. The antenna can be a beam-forming antenna that includes a radome, a beam former, and a wireless modem.

In some implementations, a set of signal parameters is associated with the network connection. The set of signal parameters can be measured at one or all of the components comprised by the relay. Additionally, the set of signal parameters can be measured at the connections between the components of the relay. For example, the method can include an operation in which a first value of the set of signal parameters is measured at the antenna.

In some implementations, the method 400 includes an operation 408 in which the antenna transmits an outdoor signal to an outdoor unit. The outdoor signal can be a first electrical signal.

The method 400 includes an operation 412 in which the outdoor unit measures parameters (signal strength, a power of the component transmitting the signal, etc.) of an outdoor signal. The outdoor signal can be an electrical signal received from an antenna. In some implementations, the parameters of the outdoor signal are measured by a management unit comprised by the relay. In some implementations, the method includes an operation in which a second value for the signal parameters is measured at the outdoor unit.

In some implementations, the method includes an operation in which an outdoor status of the network connection is predicted. The outdoor status can pertain to the outdoor signal of the network connection across the relay. The outdoor status can be predicted based on a comparison of the first value with the second value. For example, in implementations in which the signal parameters include a signal strength, the first value can indicate a strong radio signal being detected by the antenna, whereas the second value can indicate a weak electrical signal being received by the outdoor unit. The outdoor status can then be predicted by referring to a model (e.g., a Bayesian predictor), which can refer to a probability table with predicted status outputs (e.g., a compromised connection between the antenna and the outdoor unit) for components of the relay given certain signal strength inputs (e.g., a large first value, indicating a strong radio signal received by the antenna, combined with a small second value, indicating a weak electrical signal received by the outdoor unit).

The method 400 includes an operation 416 in which the outdoor unit converts an outdoor signal to an optical signal. In some implementations, the outdoor unit transforms an outdoor electrical signal into an optical signal, or it converts a first electrical signal to an optical signal.

The method 400 includes an operation 420 in which the outdoor unit transmits the optical signal to an indoor unit. In some implementations, the optical signal is transmitted across a transparent barrier (e.g., a window).

The method 400 includes an operation 424 in which the indoor unit converts the optical signal to an indoor signal. The indoor signal can be an electrical signal. In some implementations, the indoor unit transforms the optical signal into an indoor electrical signal, or it converts the optical signal to a second electrical signal.

The method 400 includes an operation 428 in which the indoor unit measures parameters of the indoor signal. In some implementations, a third value for the signal parameters is measured at the indoor unit.

The method 400 includes an operation 432 in which a status of the optical signal is predicted (e.g., a second status). The status can be predicted by a management unit. In some implementations, the management unit is comprised by the indoor unit. For example, predicting an indoor status of the network connection can be based on a comparison of the third value of the signal parameters with the second value. In some implementations, the status of the optical signal is predicted based on a comparison of the first electrical signal with the second electrical signal. For example, the signal parameters can include a signal strength, and measuring the third value for the signal parameters at the indoor unit can include detecting a drop in the signal strength from the second value at the outdoor unit. Predicting the indoor status can include predicting a cause for the drop in the signal strength based on the first value, the second value, and the third value of the signal parameters. The first electrical signal can include a first data throughput, the optical signal can include a second data throughput, and the second status can include a drop from the first data throughput to the second data throughput.

The method 400 includes an operation 436 in which a recommended action is communicated to a user. Communicating the recommended action can include identifying a recommended action to develop the network connection across the relay. The recommended action can be identified based on the first status and the second status, or based on a combination of the indoor status and the outdoor status. For example, the recommended action can include correcting a position of the indoor unit relative to the outdoor unit. In some implementations, developing the network connection can include maximizing a throughput of the optical signal from the outdoor unit to the indoor unit, or vice versa. The recommended action can include changing an alignment of the indoor unit relative to the outdoor unit. Identifying the recommended action can include determining a corrective action to rectify a drop in signal strength based on a predicted cause. In some implementations, the recommended action can include correcting a position of the antenna relative to a passing satellite, and developing the network connection can include boosting the outdoor radio signal detected by the antenna.

The method 400 can also include providing the recommended action to a user. The recommended action can be provided as multimedia feedback (e.g., haptic feedback, auditory feedback, visual feedback, video, text, and/or images). For example, providing the recommended action to the user can include generating for display, on the user equipment, a notification. The notification can include an alert to a user of the signal loss, the predicted cause, and/or the corrective action to reduce the signal loss. Feedback generated on the user equipment can include a recommended new position for the indoor unit (e.g., a new position predicted to increase data throughput), and a new signal strength based on the recommended new position.

In some implementations, the method 400 can include relaying a confirmation of the corrective action from the user equipment to a component of the relay (e.g., the antenna). Relaying the confirmation of the corrective action can include transforming the corrective action to a corrective radio signal. Relaying the confirmation can further include transmitting the corrective radio signal from the user equipment to the Wi-Fi router, and transforming the corrective radio signal to a first corrective electrical signal. Such methods can also include transmitting the first corrective electrical signal from the Wi-Fi router to the indoor unit. Additionally, such methods can include transforming the first corrective electrical signal to a corrective optical signal. The corrective optical signal can be transmitted to the outdoor unit and transformed to a second corrective electrical signal. The second corrective electrical signal can be transmitted to the antenna.

In some implementations, relaying the confirmation of the corrective action includes executing the corrective action at a relevant component. For example, relaying a confirmation of a misaligned antenna can include changing the position of the misaligned antenna relative to a passing satellite in order to boost the network connection at the point of the detected drop in signal (e.g., the outside radio signal).

In some implementations, the relay includes a router. In such implementations, the method 400 includes transforming the optical signal into an indoor electrical signal at the indoor unit can also include transmitting the indoor electrical signal from the indoor unit to the router. Additionally, the method 400 can include an operation in which a fourth value for the signal parameters is measured at the router. The method 400 can include an operation in which a router status of the network connection is predicted based on a comparison of the fourth value with the third value. The method 400 can include transforming the indoor electrical signal into an indoor radio signal at the router, or converting the second electrical signal to a radio signal at the router.

In some implementations, the relay also includes a user equipment (e.g., a mobile device). The method 400 can include transmitting the indoor radio signal from the router to the user equipment. Additionally, the method 400 can include converting the radio signal to a data stream at the user equipment. The method 400 can include measuring a fifth value for the signal parameters at the user equipment. The method 400 can include predicting an equipment status of the network connection based on a comparison of the fifth value with the fourth value. In some implementations, identifying the recommended action to develop the network connection is based on a combination of the outdoor status, the indoor status, the router status, and the equipment status. Providing the recommended action to the user can include generating the multimedia feedback on the user equipment.

Predicting the second status of the radio signal can be based on a comparison of the second electrical signal with the data stream. Identifying the recommended action to develop the network connection can be based on the second status, and providing the recommended action to the user can include generating a feedback on the user equipment.

In some implementations, the system includes a power system. The method 400 can include convert a first electrical power signal to a radio power signal at an indoor wireless power unit; convert the radio power signal to a second electrical power signal at an outdoor wireless power unit. predict a power status of the radio power signal based on a comparison of an indoor power level of the indoor wireless power unit with an outdoor power level of the outdoor wireless power unit; and provide a recommended power action to a user based on a comparison of the second power status with the first power status.

In some implementations, the recommended power actions include correcting an alignment between the indoor wireless power unit and the outdoor wireless power unit. Recommended power actions can include correcting a distance between the indoor wireless power unit and the outdoor wireless power unit. Recommended power actions can also include changing a position of a shield to protect the system from external electromagnetic interference, and/or changing a frequency of the indoor wireless power unit and the outdoor wireless power unit. Additionally, recommended power actions can include matching an impedance of the indoor wireless power unit and the outdoor wireless power unit (e.g., to reduce reflection and maximize power transfer).

In some implementations, developing the network connection includes an installation process. The installation process can include determining a status of the indoor unit (e.g., powered, or unpowered). In the installation process, the signal parameter can include an operating status for the indoor unit (e.g., ‘OK,’ or ‘failed’). The signal parameter can also include a mode of the indoor unit. Modes for the indoor unit can include searching for the outdoor unit (e.g., the indoor unit is looking for its outdoor unit partner), detecting the outdoor unit, and connected to the outdoor unit. The ‘connected’ mode can include a connection quality (e.g., poor, good, or excellent). The modes of the indoor unit can be operations of the method 400, in which case the method 400 includes the indoor unit searching for the outdoor unit, the indoor unit detecting the outdoor unit, and/or the indoor unit evaluating a connection quality to the outdoor unit.

In the method 400, the operating status can be reported by the indoor unit in a self-test. The operating status and the mode can be identified from the third value. The operating status and mode can be reported to the user as a notification on the user equipment, along with a recommended action based on the connection quality to the outdoor unit, the mode of the indoor unit, the operating status, and/or the indoor status. For example, recommended actions can include directions to a user to move the indoor unit to improve beam throughput, to reset the indoor unit if an operating status indicates an installation failure, or to turn on the indoor unit if a status indicates that it is unpowered.

In some implementations, developing the network connection includes establishing connectivity to a network. In some implementations, establishing connectivity to a network includes detecting network-serving satellites visible in the sky. The network-serving satellites can be home network-serving satellites, roaming network-serving satellites, or both.

The method 400 can include measuring a Reference Signal Received Power (RSRP) from candidate network-serving satellite. The method 400 can include measuring a Reference Signal Received Quality (RSRQ) from each candidate network-serving satellite. Additionally, the method 400 can include selecting and attaching to a network serving cell. The method 400 can include predicting a maximum High-Speed Internet (HSI) data throughput or grade of service from the selected and attached serving cell. The method 400 can include determining an actual home network data throughput. The network can be a home network or a roaming network.

Developing the network connection can include establishing relay connectivity to Narrow Band-Internet of Things (NB-IOT) devices. Establishing relay connectivity to NB-IOT devices can include connecting to NB-IOT devices (e.g., smart utility meters and smart appliances), determining a status of the NB-IOT devices, and monitoring and managing the NB-IOT devices.

Developing the network connection can include generating relay alerts. Generating relay alerts can include receiving network broadcast alerts for an area around the relay. Relay alerts can include weather, safety, emergency, and hazard alerts. Receiving network broadcast alerts can also include receiving commercial announcements.

Developing the network connection can include providing relay management functionality. Relay management functions can include a function that enables the relay to attach or detach from a wireless network. Additional functions include a relay reset, a relay self-test, and a function enabling the relay to opt in or opt out of a hosting role. The hosting role can enable the relay to host connectivity for other relays, such that the other relays can perform ancillary functions. In some implementations, performing ancillary functions includes managing NB-IOT devices, and/or opting in or opting out of receiving broadcast alerts. Managing NB-IOT devices can include setting heating and cooling thermostats, setting timers for sprinklers, security alarms, and locking or unlocking entryways, with potential branch menus depending on the NB-IOT range of functionalities. Additionally, ancillary functions can include relaying messages and data for car-to-car communication, public safety, delivery services, local area networks, as well as sensing and/or monitoring of microclimates.

### Computer System

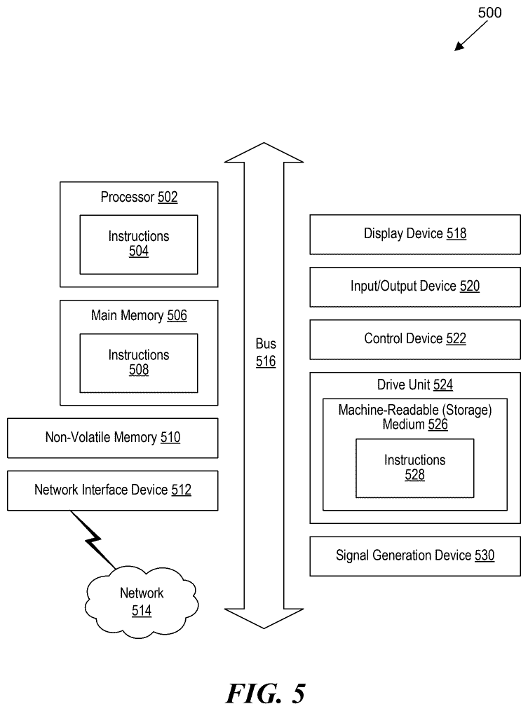

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method of developing a network connection across a relay with multimodal signals, the relay comprising a satellite terminal system including an antenna, an outdoor unit, and an indoor unit, the method comprising:
detecting an outdoor radio signal comprising the network connection at the antenna;
transforming the outdoor radio signal into an outdoor electrical signal at the antenna;
transmitting the outdoor electrical signal from the antenna to the outdoor unit;
measuring a first value of a set of signal parameters associated with the network connection at the antenna;
measuring a second value for the set of signal parameters at the outdoor unit;
predicting an outdoor status of the network connection by comparing the first value with the second value;
transforming the outdoor electrical signal into an optical signal at the outdoor unit;
transmitting the optical signal from the outdoor unit to the indoor unit across a transparent barrier;
transforming the optical signal into an indoor electrical signal at the indoor unit;
measuring a third value for the set of signal parameters at the indoor unit;
predicting an indoor status of the network connection by comparing the third value with the second value;
identifying a recommended action to develop the network connection across the relay based on a combination of the indoor status and the outdoor status; and
providing the recommended action to a user as multimedia feedback.

2. The method of claim 1,
wherein the relay further includes a router and a user equipment,
wherein transforming the optical signal into the indoor electrical signal at the indoor unit further comprises:
transmitting the indoor electrical signal from the indoor unit to the router;
measuring a fourth value for the set of signal parameters at the router;
predicting a router status of the network connection by comparing the fourth value with the third value;
transforming the indoor electrical signal into an indoor radio signal at the router;
transmitting the indoor radio signal from the router to the user equipment;
measuring a fifth value for the set of signal parameters at the user equipment; and
predicting an equipment status of the network connection by comparing the fifth value with the fourth value,
wherein identifying the recommended action to develop the network connection is further based on the outdoor status, the indoor status, the router status, and the equipment status, and
wherein providing the recommended action to the user comprises generating the multimedia feedback on the user equipment.

3. The method of claim 2, wherein developing the network connection comprises correcting a position of the indoor unit relative to the outdoor unit to maximize throughput of the optical signal,
wherein the set of signal parameters include a signal strength,
wherein measuring the third value for the set of signal parameters at the indoor unit comprises:
detecting a drop in the signal strength from the second value at the outdoor unit,
wherein predicting the indoor status comprises:
predicting a cause for the drop in the signal strength based on the first value, the second value, and the third value of the set of signal parameters,
wherein identifying the recommended action comprises:
determining a corrective action to correct the drop in the signal strength based on the cause that was predicted, and
wherein providing the recommended action to the user comprises:
generating for display, on the user equipment, a notification, including at least one of:
an alert to the user of the drop in the signal strength,
the cause predicted, and
the corrective action to rectify the drop in the signal strength.

4. The method of claim 2, wherein developing the network connection comprises correcting a position of the antenna relative to a passing satellite to boost the outdoor radio signal,
wherein the set of signal parameters include a signal strength,
wherein measuring the first value for the set of signal parameters at the antenna comprises:
detecting a weak signal strength of the outdoor radio signal, and
wherein providing the recommended action to the user comprises:
relaying a confirmation from the user equipment to the antenna, wherein the confirmation indicates the recommended action has been performed as a corrective action.

5. The method of claim 4, wherein relaying the confirmation of the recommended action to the antenna comprises:
transforming the corrective action to a corrective radio signal;
transmitting the corrective radio signal from the user equipment to the router,
transforming the corrective radio signal to a first corrective electrical signal;
transmitting the first corrective electrical signal from the router to the indoor unit;
transforming the first corrective electrical signal to a corrective optical signal;
transmitting the corrective optical signal to the outdoor unit;
transforming the corrective optical signal to a second corrective electrical signal;
transmitting the second corrective electrical signal to the antenna; and
correcting the position of the antenna relative to the passing satellite based on the corrective action.

6. The method of claim 1, wherein developing the network connection comprises an installation process, and wherein the installation process comprises:
determining a power status from the indoor status;
detecting the third value for the set of signal parameters at the indoor unit,
wherein the set of signal parameters comprises an operating status and a mode,
wherein the operating status is reported by the indoor unit in a self-test;
identifying the operating status from the third value;
identifying the mode of the indoor unit from the third value, wherein the mode comprises:
searching for the outdoor unit;
detecting the outdoor unit; or
evaluating a connection quality to the outdoor unit, the connection quality comprising:
poor, good, or excellent; and
recommending an action to the user based on the connection quality to the outdoor unit, the mode of the indoor unit, the operating status, and the indoor status.

7. The method of claim 1, wherein developing the network connection comprises establishing connectivity to a network, and wherein establishing relay connectivity to the network comprises:
detecting candidate network-serving satellites;
measuring a Reference Signal Received Power (RSRP) from each candidate network-serving satellite;
measuring a Reference Signal Received Quality (RSRQ) from each candidate network-serving satellite;
selecting and attaching to a network-serving cell;
predicting a maximum High-Speed Internet (HSI) data throughput or grade of service from the network-serving cell; and
determining an actual home network data throughput.

8. The method of claim 7, wherein the network comprises a home network or a roaming network, and wherein the candidate network-serving satellites comprise at least one of: home network-serving satellites, or roaming network-serving satellites.

9. The method of claim 1, wherein developing the network connection comprises establishing relay connectivity to Narrow Band-Internet of Things (NB-IOT) devices, and wherein establishing the relay connectivity to NB-IOT devices comprises:
connecting to the NB-IOT devices, including smart utility meters and smart appliances;
determining a status of the NB-IOT devices; and
monitoring and managing the NB-IOT devices.

10. The method of claim 1, wherein developing the network connection comprises generating relay alerts, comprising:
receiving network broadcast alerts for an area around the relay, including weather, safety, emergency, and hazard alerts; or
receiving commercial announcements.

11. The method of claim 1, wherein developing the network connection comprises providing relay management functionality, comprising:
attaching or detaching the relay from a wireless network;
a relay reset;
a relay self-test;
opting in or opting out of a hosting role, wherein the hosting role comprises hosting connectivity to other relays for ancillary functions;
managing NB-IOT devices; and
opting in or opting out of receiving broadcast alerts.

12. A system configured to develop a network connection by relaying multimodal signals, the system comprising:
an antenna, configured to receive outdoor radio signals and convert them into outdoor electrical signals;
an outdoor unit, configured to receive the outdoor electrical signals from the antenna and convert them into optical signals;
an indoor unit, configured to receive the optical signals from the outdoor unit and convert them into indoor electrical signals; and
a management unit, configured to:
monitor the outdoor radio signals, the outdoor electrical signals, and the indoor electrical signals,
measure changes in signal parameters,
predict statuses for the antenna, the outdoor unit, and the indoor unit based on the changes in the signal parameters, and
provide recommended actions to a user based on the statuses predicted,
wherein the outdoor unit and the indoor unit are separated by a barrier.

13. The system of claim 12, further comprising:
a Wi-Fi router, configured to receive the indoor electrical signals from the indoor unit and convert them into indoor radio signals; and
a user equipment, configured to receive the indoor radio signals from the Wi-Fi router and convert them into data, including the recommended actions to develop the network connection comprising multimedia feedback,
wherein the management unit is further configured to:
monitor the indoor radio signals,
measure the changes in the signal parameters associated with the indoor radio signals, and
predict the statuses for the Wi-Fi router and the user equipment.

14. The system of claim 12, further comprising a power system, including:
an indoor power supply, configured to collect power from a power source and conduct collected power to the indoor unit;
an indoor wireless power unit, configured to receive the collected power from the indoor power supply and radiate it;
an outdoor wireless power unit, configured to harvest radiated power from the indoor wireless power unit, and to conduct harvested power to the outdoor unit and to the antenna,
wherein the indoor wireless power unit and the outdoor wireless power unit are separated by the barrier,
wherein the management unit is further configured to:
monitor the collected power, the radiated power, and the harvested power for power fluctuations across the system,
predict power statuses for the indoor power supply, the indoor wireless power unit, and the outdoor wireless power unit based on the changes, and
provide recommended power actions to the user based on the power statuses predicted.

15. The system of claim 14, wherein the recommended actions comprise at least one of:
changing a position of the indoor wireless power unit, or the outdoor wireless power unit, or both, for proper alignment for power radiation and harvesting,
checking to ensure the indoor power supply is properly connected to the power source, and
examining connections between the indoor power supply and the indoor unit, between the outdoor wireless power unit and the outdoor unit, and between the outdoor wireless power unit and the antenna, to ensure the connections are secure and undamaged.

16. A non-transitory, computer-readable storage medium comprising instructions recorded thereon, wherein the instructions when executed by at least one data processor of a system, cause the system to:
convert a first electrical signal to an optical signal at an outdoor unit;
convert the optical signal to a second electrical signal at an indoor unit;
predict a status of the optical signal based on a comparison of the first electrical signal with the second electrical signal;
identify a recommended action to develop a connection based on the status of the optical signal; and
provide the recommended action to a user.

17. The non-transitory, computer-readable storage medium of claim 16, wherein converting the first electrical signal to the optical signal further causes the system to:
convert the second electrical signal to a radio signal at a router;
convert the radio signal to a data stream at a user equipment; and
predict a second status of the radio signal by comparing the second electrical signal with the data stream,
wherein identifying the recommended action to develop the connection is further based on the second status, and
wherein providing the recommended action to the user further comprises generating a feedback on the user equipment.

18. The non-transitory, computer-readable storage medium of claim 17, wherein:
the first electrical signal comprises a first data throughput,
the optical signal comprises a second data throughput,
the second status comprises a drop from the first data throughput to the second data throughput,
the recommended action comprises changing an alignment of the indoor unit relative to the outdoor unit, and
the feedback generated on the user equipment includes at least one of:
a recommended new position for the indoor unit predicted to increase data throughput, and
a new signal strength based on the recommended new position.

19. The non-transitory, computer-readable storage medium of claim 16, wherein the system comprises a power system, and wherein the instructions further cause the power system to:
convert a first electrical power signal to a radio power signal at an indoor wireless power unit;
convert the radio power signal to a second electrical power signal at an outdoor wireless power unit;
predict a power status of the radio power signal by comparing an indoor power level of the indoor wireless power unit with an outdoor power level of the outdoor wireless power unit; and
provide a recommended power action to the user based on the power status predicted.

20. The non-transitory, computer-readable storage medium of claim 19, wherein the recommended power action comprises at least one of:
correcting an alignment between the indoor wireless power unit and the outdoor wireless power unit,
correcting a distance between the indoor wireless power unit and the outdoor wireless power unit,
changing a position of a shield to protect the system from external electromagnetic interference,
changing a frequency of the indoor wireless power unit and the outdoor wireless power unit, and
matching an impedance of the indoor wireless power unit and the outdoor wireless power unit to reduce reflection and maximize power transfer.
